(19) United States
(12) Patent Application Publication
(10) Pub. No.: US 2005/0033556 A1
(43) Pub. Date: Feb. 10, 2005

(54) Diagnostic apparatus and diagnostic system on which the diagnostic apparatus is mounted

(75) Inventor: Keisuke Miura, Tokyo (JP)

Correspondence Address: OSTROLENK FABER GERB & SOFFEN, 1180 AVENUE OF THE AMERICAS, NEW YORK, NY, 100368403, US

(73) Assignee: Olympus Corporation

(21) Appl. No.: 10/912,913

(22) Filed: Aug. 6, 2004

(30) Foreign Application Priority Data
Aug. 6, 2003 (JP) 2003-287793
May 28, 2004 (JP) 2004-158912

(51) Int. Cl. G06F 19/00

(52) U.S. Cl. 702/183; 702/20

(57) ABSTRACT

There is disclosed a diagnostic apparatus which detects histopathological information from a biomedical tissue of a patient by a genetic information detection section disposed in an operation instrument during an operation, collates the information with a pathology database disposed in another place through communication between a detection processing/information transmission section and an information reception section, causes a pathologist to make verification or a judgment with respect to obtained diagnostic information, and quickly notifies the diagnostic information to a surgeon through communication. There is also disclosed a diagnostic system on which the diagnostic apparatus is mounted.

### CROSS-REFERENCE TO RELATED APPLICATIONS

This application is based upon and claims the benefit of priority from prior Japanese Patent Application No. 2003-287793, filed Aug. 6, 2003, the entire contents of which are incorporated herein by reference.

### BACKGROUND OF THE INVENTION

1. Field of the Invention

The present invention relates to a diagnostic apparatus which comprises a sensor mounted on an operation instrument to diagnose a tissue/affected portion, and a diagnostic system on which the diagnostic apparatus is mounted.

2. Description of the Related Art

Generally, a surgeon wishes to quickly obtain histopathological information during an operation if an actual finding is different from what has been initially expected, or a cutting range must be decided on the spot.

A diagnosis made in such a case is generally called “an intraoperative quick pathological diagnosis” (hereinafter refer to as intraoperative quick diagnosis). The intraoperative quick diagnosis is an inspection which prepares a tissue sample during the operation to make a diagnosis. This inspection is important in that an improvement of a treatment effect can be expected as it determines an effect of cutting-off or a necessity of additional cutting-off during operation.

As a device that uses a microscope remote observation system in the intraoperative quick diagnoses, for example, Jpn. Pat. Appln. KOKAI Publication No. 7-95556 discloses an exemplary device. According to the microscope remote observation system disclosed therein, a pathologist who is a remote operator operates an observation side terminal, remotely observes a microscope through a microscope terminal section installed in a remote pathology room connected through a transmission line to the system, and gives advice to a doctor in charge in the pathological room.

As a diagnostic technology, Jpn. Pat. Appln. KOKAI Publication No. 2000-117138 discloses a medical system which makes a diagnosis by using genetic information of a patient.

### BRIEF SUMMARY OF THE INVENTION

A first aspect of the present invention is directed to a diagnostic apparatus comprising genetic information detection means for obtaining a part of a biomedical tissue, and executing hybridization to detect genetic information of the biomedical tissue; transmission/reception means for converting the genetic information detected by the genetic information detection means into an electric signal to execute communication; a pathology database in which a plurality of bits of diagnostic information concerned with a plurality of kinds of genetic information are prestored; diagnostic information search means for collating the genetic information received from the transmission/reception means with the pathology database to search the relevant diagnostic information; and display means for displaying the diagnostic information searched by the diagnostic information search means.

A second aspect of the present invention is directed to a diagnostic system on which a diagnostic apparatus is mounted, comprising forceps having a genetic information detection mechanism which includes a DNA chip disposed at a tip of a jaw, executes hybridization of a biomedical tissue stuck to the DNA chip, converts optically detected genetic information into an electric signal, and outputs the electric signal; a detection processing/information transmission section which is connected to a handle side of the forceps and which supplies/recovers a drug solution for the execution of the hybridization, propagates an irradiating light to the DNA chip, converts the genetic information converted into the electric signal into a radio signal, and transmits the radio signal; an information reception section which is present apart from the detection processing/information transmission section and which receives the radio signal from the detection processing/information transmission section, and decodes the genetic information; a pathology database in which diagnostic information concerned with a plurality of kinds of genetic information is prestored; a diagnostic information search section which collates the received genetic information with the pathology database to search the relevant diagnostic information; verification display means for displaying to verify that the diagnostic information searched by the diagnostic information search section is correct; and a display section which displays the diagnostic information verified to be correct by the verification display means in the vicinity of a place in which the forceps are present.

### BRIEF DESCRIPTION OF THE SEVERAL VIEWS OF THE DRAWING

FIG. 1A is a block constitutional diagram showing a constitutional example of an entire diagnostic apparatus of the present invention;

FIG. 1B is a view showing a constitutional example of a genetic information detection section;

FIG. 2A is a view showing a constitution of an operation portion seen from above;

FIG. 2B is a view showing a sectional constitution of the operation portion;

FIG. 3A is a view showing a constitution of a preprocessing/observation section in the genetic information detection section;

FIG. 3B is a view showing a constitutional example of a reference cell;

FIG. 3C is a view showing a sectional constitution of the reference cell;

FIG. 4 is a view showing and explaining a specific constitution of a detection processing/information transmission section;

FIG. 5 is a view illustrating a diagnostic system which uses the diagnostic apparatus of the invention according to a first embodiment;

FIG. 6A is a view showing a constitution of a preprocessing/observation section in a genetic information detection section of the first embodiment;

FIG. 6B is a view showing a constitutional example of a reference cell;

FIG. 6C is a view showing a sectional constitution of the reference cell;

FIG. 7 is a view illustrating a diagnostic system which uses the diagnostic apparatus of the invention according to a second embodiment;

FIG. 8 is a view showing a modified example of a diagnostic system which comprises the diagnostic apparatus of the invention mounted on a laparoscopic operation instrument; and

FIG. 9 is a view illustrating a diagnostic system which uses the diagnostic apparatus of the invention according to a third embodiment.

### DETAILED DESCRIPTION OF THE INVENTION

Next, the preferred embodiments of the present invention will be described in detail with reference to the accompanying drawings.

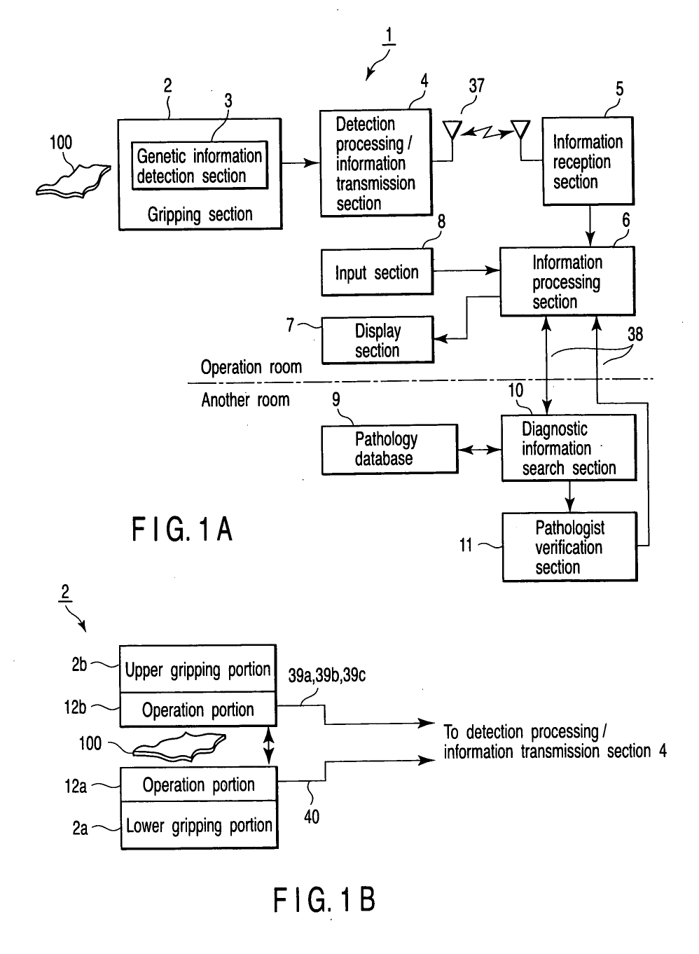

FIG. 1A is a block constitutional view showing a constitutional example of en entire diagnostic apparatus of the present invention. FIG. 1B is a block constitutional view showing a constitutional example of a genetic information detection section of FIG. 1A.

As shown in FIG. 1A, the diagnostic apparatus 1 comprises a genetic information detection section 3 disposed in a gripping section 2 for gripping a biomedical tissue (or affected portion) 100 desired to be inspected, a detection processing/information transmission section 4 connected through a cable (tube) to the genetic information detection section 3, an information reception section 5 for receiving a spot information signal (genetic information or the like of the biomedical tissue 100) transmitted from the detection processing/information transmission section 4, an information processing section 6 constituted of a personal computer to process the received information, a display section 7 for displaying the processed information, operation instructions or the like, an input section 8 constituted of an operation panel, a keyboard or the like to input instructions for setting or processing, a pathology database 9 constituted of a database of various biomedical tissues, a database of DNA or the like, a diagnostic information search section 10 for searching genetic information detected regarding information recorded in the pathology database 9 to obtain relevant diagnostic information, and a pathologist verification section 11 constituted of a personal computer or the like which displays a diagnostic result based on the diagnostic information obtained from the diagnostic information search section 10 on a built-in display section to make a pathologist verify the result (e.g., malignant, benign, or the like).

Among the constitutional sections of the diagnostic apparatus, the gripping section 2, the genetic information detection section 3, the detection processing/information transmission section 4, the information reception section 5, the information processing section 6, and the display section 7 are arranged in, e.g., an operation room in which a surgeon is present. On the other hand, the pathology database 9, the diagnostic information search section 10, and the pathologist verification section 11 need not be arranged in the operation room, but they may be interconnected through a line cable, e.g., a communication line 38 of LAN or the like, to be arranged in another room such as a central control room. In place of the communication line 38, a network such as Internet may be used to execute communication with an operation room of a remote hospital. Further, for the communication line 38, not only wire communication by the line cable but also radio or optical communication may be used. Especially, the optical communication is suited to the case of much information such as images. In the case of the radio communication, not only a ground wave (analog or digital wave) but also satellite communication may be used.

As shown in FIG. 1B, the genetic information detection section 3 comprises an operation portion 12a disposed in a lower gripping portion 2a of the gripping section 2, and an operation portion 12b disposed in an upper gripping portion 2b. When gripped, the operation portions 12a and 12b are sealed to confront each other. The operation portion 12b of these is connected to the detection processing/information transmission section 4 through an optical cable 39a (described later) to propagate an irradiating light, a cable 39b for an electric signal (genetic information) based on photoelectric conversion of a reflected light, a tube 39c for feeding a drug solution such as a cleaning solution or a target solution (sample which contains a fluorescent material and reacts with a specific DNA; hereinafter referred to simply as a sample) to execute hybridization or cleaning, or the like. Further, the operation portion 12a is connected to the detection processing/information transmission section 4 through a discharge tube 40 for discharging the drug solution. The cables and the tubes are generally integrated.

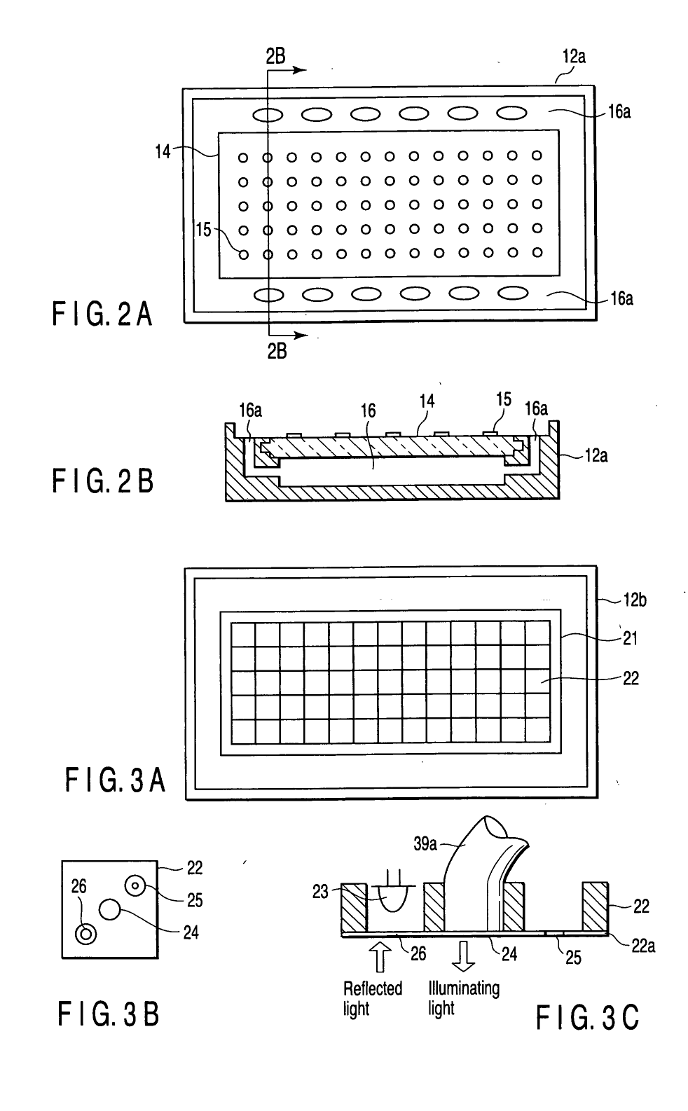

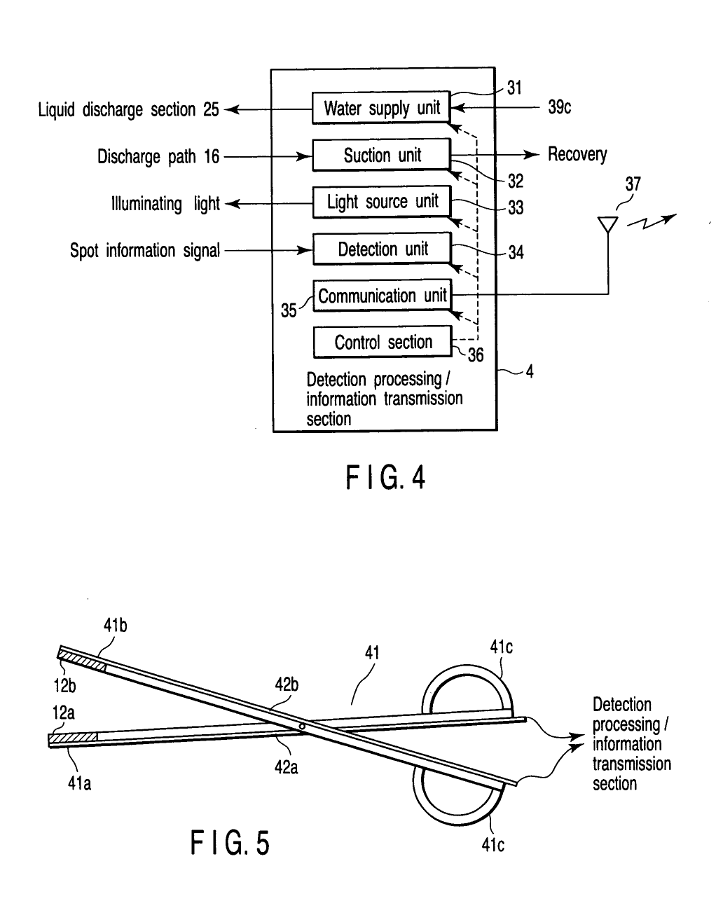

FIG. 2A shows a constitution of the operation portion 12a seen from above. FIG. 2B shows a sectional constitution (A-A) of the operation portion 12a of FIG. 2A. FIG. 3A shows a constitution of a preprocessing/observation section 21 of the operation portion 12b. FIG. 3B shows a constitutional example of a reference cell 22. FIG. 3C shows a sectional constitution of the reference cell 22. FIG. 4 shows and explains a specific constitution of the genetic information detection section 3 and the detection processing/information transmission section 4. The gripping section 2 (2a, 2b) shown in FIG. 1B is in a state in which the biomedical tissue 100 is held between the operation portion 12a and the operation portion 12b.

As shown in FIG. 2A, the operation portion 12a comprises a DNA chip 14 and a discharge opening 16a of a discharge path 16. The discharge opening 16a is not limited to a shape or an arrangement (shown).

In the DNA chip 14, many spots (or probes) 15 of a plurality of kinds of solid-phase DNA's are disposed on a plate substrate made of slide glass or the like. The spots 15 are spotted to be arrayed in a matrix or zigzag shape, thereby constituting a so-called microarray. FIG. 2A shows an example in which the spots 15 are arranged in a matrix shape. The DNA chip 14 is disposed to be detached from the operation portion 12a.

A drug solution such as a sample or a cleaning solution applied to the DNA chip 14 is discharged through the discharge path 16 when hybridization or cleaning is carried out for the same.

On the other hand, the operation portion 12b comprises the preprocessing/observation section 21 constituted of many reference cells 22 arranged to confront the spots 15 in a gripped state. A transparent member, e.g., a glass plate 22a, is disposed on a front face of the reference cell 22 to prevent incursion of the drug solution. In this example, in the reference cell 22, an irradiation opening 24 is arranged on a center to apply an illuminating light propagated through the optical cable 39a, and a liquid discharge section 25 of the drug solution and a light receiving section 26 are arranged in an oblique direction. Needless to say, these portions are not limited to such an arrangement. The light receiving section 26 comprises, e.g., a photodiode 23, which receives a reflected light containing a fluorescent color from the spot 15, and generates a signal which contains fluorescence intensity and which is generated by photoelectric conversion, or a spot information signal having spot identification information and positional information. The light receiving section 26 is not limited to the photodiode 23, but a semiconductor imaging device such as a CCD may be used.

As shown in FIG. 4, the detection processing/information transmission section 4 comprises a wafer supply unit 31, a suction unit 32, a light source unit 33, a detection unit 34, and a communication unit 35. These units are controlled by a control section 36 constituted of a personal computer or the like. The water supply unit 31 supplies a sample or a liquid such as a cleaning solution through a water supply path (tube 39c) to the liquid discharge section 25 in the DNA chip 14 to execute hybridization or cleaning. The suction unit 32 recovers the drug solution supplied to the DNA chip 14 through the discharge path 16.

The light source unit 33 is optically connected through an optical fiber 39a to an irradiation opening of each reference cell 22, and a light from the light source unit 33 is applied to each spot. The detection unit 34 includes a light receiving section 26 in the reference cell 22, and generates a spot information signal from the reacted spot 15. The communication unit 35 converts the spot information signal into a signal (radio signal, optical signal or the like) suited to communication, and transmits the signal through an antenna 37 to the information reception section 5. Incidentally, in the liquid discharge section 25, a heater for heating the sample to about 50° C. to 95° C. may be incorporated in the operation portion 12b. This heating may be used when PCR reaction is utilized.

By such a constitution, in the reference cell 22, the light transmitted through the optical fiber 39a is applied to all the spots 15, and a reflected light which contains a fluorescent color (fluorescence intensity) and which is emitted only from the spot 15 reacted by the hybridization is received by the photodiode 23. The photodiode 23 subjects the received reflected light to photoelectric conversion to generate an electric signal, and transmits the electric signal through the cable to the detection processing/information transmission section 4.

Next, description will be made of an operation in the diagnostic apparatus constituted in the aforementioned manner.

In order to obtain genetic information of the biomedical tissue 100 of a patient or the like, the biomedical tissue 100 is gripped by the gripping section 2. When gripped, a part of a surface of the biomedical tissue 100 is stuck to the DNA chip 14. Subsequently, in a state in which the gripping section 2 is removed from the biomedical tissue 100 to be closed, i.e., in a joined and sealed state of the operation portions 12a, 12b, a sample is supplied through the liquid discharge section 25 of the reference cell 22 to execute hybridization, and cleaning is carried out after reaction. Then, a light is applied through the irradiation opening 24 to all the spots 15 of the DNA chip 14. A reflected light that contains a fluorescent color from each reacted spot 15 is received by the photodiode 23, and a spot information signal (genetic information) that contains fluorescence intensity is generated by photoelectric conversion. This spot information signal is subjected to predetermined processing such as amplification or noise removal by the detection unit 34, then converted into a radio signal by the detection processing/information transmission section 4, and transmitted to the information reception section 5 by radio. The information reception section 5 decodes the received spot information signal to generate genetic information, and outputs the genetic information to the information processing section 6.

The information processing section 6 makes a diagnosis based on the genetic information by a predetermined sequence (program). To begin with, the genetic information is sent to the diagnostic information search section 10. Here, the genetic information is collated with data (pre-recorded data or past stored data) recorded in the pathology database 9, and relevant data (diagnostic information) is read. The diagnostic information search section 10 transfers the read diagnostic information to the pathologist verification section 11, and displays the diagnostic information. The pathologist verifies that the diagnostic information is correct. Needless to say, if there is no relevant data in the database, and no diagnostic information is obtained, the pathologist makes a diagnosis. The verified item is returned together with the diagnostic information to the information processing section 6, and displayed on the display section 7.

An operation method (e.g., cutting range) is considered with reference to the diagnostic information and the verified item of the pathologist, or the diagnostic information.

As described above, the diagnostic apparatus of the present invention detects histopathological information in the operation room or the like, and collates the information with the database disposed in another place through communication. The pathologist makes verification or a diagnosis for a result of the collation, and the diagnostic information is quickly notified to the surgeon. Accordingly, time necessary for a diagnosis is shortened, i.e., time necessary for an operation can be shortened, and accuracy of the diagnosis can be improved. Thus, it is possible to reduce a burden on the surgeon or the patient during the operation.

Next, description will be made of a diagnostic system which uses the aforementioned diagnostic apparatus according to a first embodiment. FIG. 5 shows a constitutional example in which the gripping section 2 and the genetic information detection section 3 of the diagnostic apparatus are mounted on inspection forceps 41. Components of the diagnostic system similar to those shown in FIG. 1A to FIG. 4 are denoted by similar reference numerals, and detailed description thereof will be omitted.

The inspection forceps 41 grip a biomedical tissue (or affected portion) 100 desired to be inspected. The genetic information detection section 3 is disposed in lower and upper jaws 41a and 41b at tips of the inspection forceps 41. The genetic information detection section 3 is connected through forceps inner diameter paths 42a, 42b disposed in the inspection forceps 41 from a handle 41c side through a cable (and a tube) to the detection processing/information transmission section 4.

In addition to the above, the diagnostic system comprises the information reception section 5, the information processing section 6, the display section 7, the input section 8, the pathology database 9, the diagnostic information search section 10, and the pathologist verification section 11 as shown in FIG. 1A. However, description thereof will be omitted.

In the inspection forceps 41, the biomedical tissue 100 is held between the lower and upper jaws 41a, 41b, and brought into contact with the spot 15 to be partially stuck thereto. The operation portion 12a of the genetic information search section 3 is disposed in the lower jaw 41a, and the operation portion 12b is disposed in the upper jaw 41b. In a gripped state, the lower jaw 41a and the upper jaw 41b are sealed.

After the partial sticking, the inspection forceps 41 are separated from the biomedical tissue 100. The inspection forceps 41 are gripped again to be sealed, and a sample is injected to execute hybridization. Additionally, the detection processing/information transmission section 4 is disposed on the handle 41c side to be connected therewith through the cable, the tube, and the like.

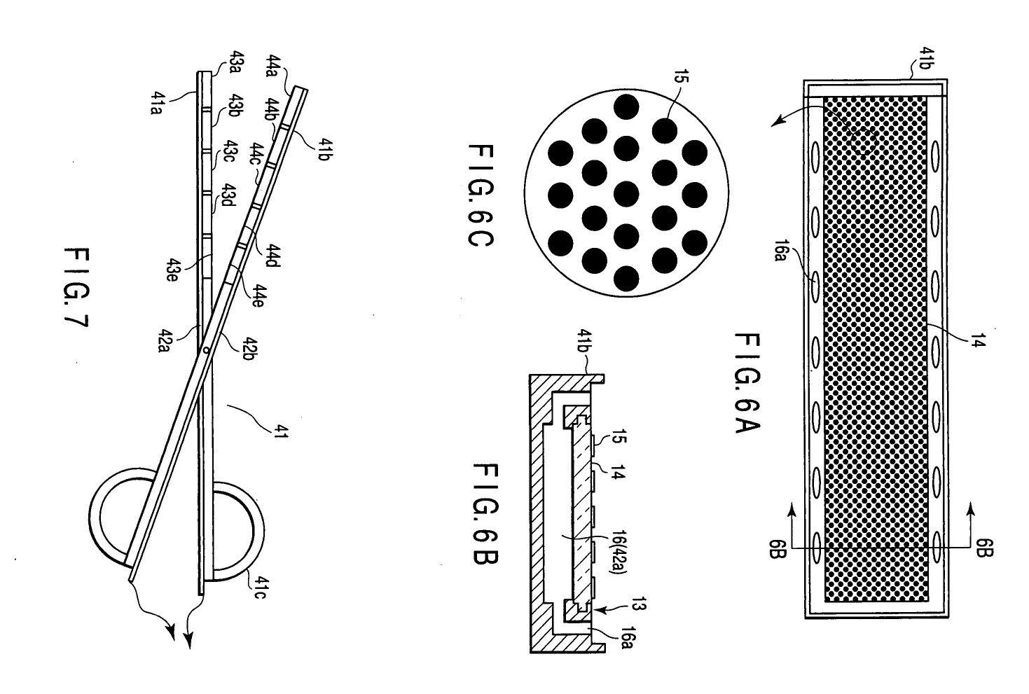

FIG. 6A shows a constitution in which the operation portion 12a disposed in the inspection forceps 41 is seen from above. FIG. 6B shows a sectional constitution of the lower jaw 41a cut along the line B-B of FIG. 6A. FIG. 6C shows a constitutional example of the spot 15 of the DNA chip 14.

A plurality of rows of spots (or probes) 15 of the DNA chip 14 in the inspection forceps 41 are alternately arranged. A discharge opening 16a is disposed around the DNA chip 14 to suck/discharge a sample or a drug solution such as a cleaning solution. A discharge path 16 is formed in the lower jaw 41a in a longitudinal direction directed to the handle 41c side, and a guide groove 13 is disposed in both inner side surfaces thereof. By opening a movable portion 41b of the tip of the lower jaw 41a, the DNA chip 14 is fitted into the guide groove 13, and slid to be fixed. The DNA chip 14 is replaceable.

As shown in FIG. 6B, in the lower jaw 41a, a discharge path 16 (forceps inner diameter path 42a) is formed in a lower part in a state in which the DNA chip 14 is fitted into the guide groove 13. The discharge path 16 is connected to a plurality of liquid discharge openings 16a disposed in the lower jaw 41a in the vicinity of the DNA chip 14. The discharge path 16 is formed from the backside of the DNA chip 14 through the handle 41c side, and connected to the aforementioned suction unit 32. When hybridization or cleaning is carried out in the DNA chip 14, a sample or a drug solution such as a cleaning solution applied thereto is removed through the liquid discharge opening 16a and the discharge path 16 to the handle 41c side, and recovered by the suction unit 32.

On the other hand, in the upper jaw 41b, a preprocessing/observation section 21 which comprises many reference cells 22 to confront the spots 15 as in the aforementioned case is disposed. Specific description of the reference cells 22 will be omitted.

Next, description will be made of a diagnosis by the diagnostic system which uses the inspection forceps 41.

The specific description of the diagnostic system is similar to that of the operation of the diagnostic apparatus, and characteristic portions of the system will be described. To begin with, the diagnostic system is started to make the genetic information detection section 3 capable of detecting genetic information.

The surgeon or the like in the operation room grips the biomedical tissue 100 of the patient to be diagnosed by the lower and upper jaws 41a, 41b of the inspection forceps 41, and sticks a part of a surface of the biomedical tissue 100 to the DNA chip 14. Subsequently, the lower and upper jaws 41a, 41b are removed from the biomedical tissue 100 to be joined and sealed. In this state, a sample is supplied through the liquid discharge opening 25 of the reference cell 22 to execute hybridization, and cleaning is carried out after reaction. Then, an illuminating light is applied to all the spots 15 of the DNA chip 14, and a spot information signal (genetic information) that contains fluorescence intensity is generated based on a reflected light obtained from each reacted spot 15, and input to the information processing section 6.

In the information processing section 6, the genetic information is sent to the diagnostic information search section 10, and collated with the data recorded in the pathology database 9 there to read relevant data (diagnostic information). The read diagnostic information is transferred from the diagnostic information search section 10 to the pathologist verification section 11, and displayed. The pathologist verifies that the displayed diagnostic information is correct. Needless to say, the pathologist may make a diagnosis. For example, if there is diagnostic processing for a cancer operation, it is only necessary to distinguish a cancel cell from a normal cell. Thus, a normal biomedical tissue of the patient may be taken out to record a normal DNA pattern before an operation, and a DNA pattern collected from an affected portion is compared therewith to make a diagnosis during the operation.

The verified item is displayed on the display section 7 disposed in the operation room. The surgeon decides an operation method (e.g., a cutting range) with reference to the diagnostic information and the verified item of the pathologist or the diagnostic information.

As described above, according to the intraoperative quick diagnosis by the diagnostic system of the embodiment, the histopathological information is detected in the operation room, collated with the database disposed in another place through communication, verification and a diagnosis are carried out by the pathologist, and the diagnostic information is quickly notified to the surgeon. Thus, time necessary for a diagnosis is shortened, i.e., time necessary for an operation can be shortened, and accuracy of a diagnosis can be improved. As a result, it is possible to reduce a burden on the surgeon or the patient during the operation.

Next, description will be made of a diagnostic system according to a second embodiment of the present invention.

According to the foregoing first embodiment, one DNA chip 14 is disposed in the inspection forceps 41, and a diagnosis is made at one place by an amount equal to one DNA chip area. However, the second embodiment employs a constitution in which an area of one diagnosis is expanded by disposing a plurality of DNA chips in the inspection forceps 41.

As shown in FIG. 7, a plurality of (e.g., 5) DNA chips 43a to 43e are disposed in the lower jaw 41a of the inspection forceps 41. In the upper jaw 41b, preprocessing/observation sections 44a to 44e are disposed as in the aforementioned case to confront the DNA chips 43a to 43e when the inspection forceps 41 is gripped. Other components are similar to those of the first embodiment. However, since the number of cables or the like and a processing amount are increased equally to the increase of DNA chips, a corresponding constitution is accordingly employed.

According to the diagnostic system constituted in the aforementioned manner, as in the case of the first embodiment, after a biomedical tissue of an affected portion of a subject or a patient is stuck to the inspection forceps 41, hybridization or cleaning is carried out to cause reaction of the DNA chips. A light is applied to the DNA chips 43a to 43e, and an intraoperative quick diagnosis is made based on genetic information obtained from a reflected light.

As described above, if an inspection target range exceeds the inspection range (area of the DNA chip) of the first embodiment, the inspection must be repeated. According to the second embodiment, however, it is possible to obtain diagnostic information of a wider inspection range by one inspection.

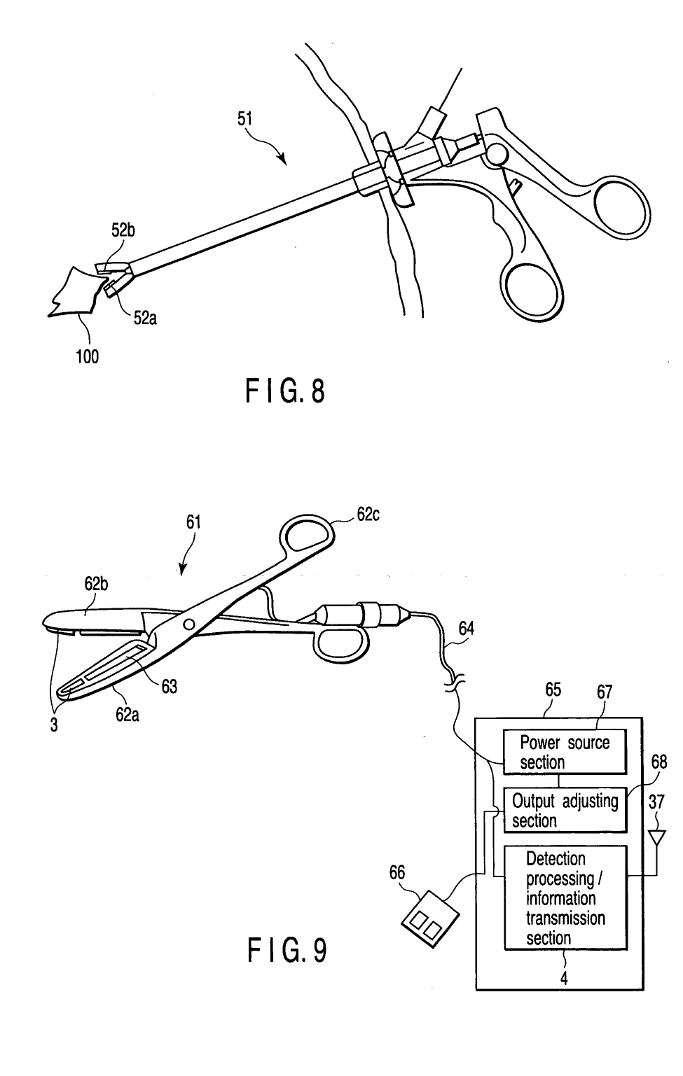

Additionally, according to a modified example of the first and second embodiments, a genetic information detection section 3 is mounted on the inspection forceps 41, i.e., forceps used for an abdominal operation. However, for example, as shown in FIG. 8, the genetic information detection section 3 may be similarly mounted on a laparoscopic operation instrument 51. Regarding components other than the genetic information detection section 3, components similar to those of the first embodiment are used to configure a system.

In the operation instrument 51, operation portions 12a, 12b are disposed in tips 52a, 52b of a gripping section 52.

Next, description will be made of an energy treatment tool of a diagnostic system according to a third embodiment of the present invention.

According to the aforementioned first and second embodiments, the genetic information detection section 3 is disposed in the inspection forceps. According to the third embodiment, however, the genetic information detection section 3 is disposed in the energy treatment tool which can treat a biomedical tissue. In the diagnostic system of the embodiment, components other than the energy treatment tool are similar to those of the first embodiment, and denoted by similar reference numerals, and detailed description thereof will be omitted.

As shown in FIG. 9, the genetic information detection section 3 is disposed in tips 62a, 62b of both gripping sections 62 of an energy treatment tool 61. A treatment section 63 is disposed on a handle 62c side of the gripping section 62. The energy treatment tool 61 is connected through a cable (including a sample tube) 64 to a treatment tool driving controller 65. In the treatment tool driving controller 65, a foot switch 66 is disposed to turn ON/OFF driving power supplied to the treatment section 63.

The treatment tool driving controller 65 comprises a power source section 67 for driving the treatment section 63, an output adjusting section 68 for adjusting an output or the like of the power source section 67, and a detection processing/information transmission section 4. As described above, the detection processing/information transmission section 4 comprises a water supply unit 31, a suction unit 32, a light source unit 33, a detection unit 34, and a communication unit 35.

The energy treatment tool 61 constituted in the aforementioned manner first obtains genetic information by the genetic information detection section 63 by a procedure similar to that of the first embodiment. A surgeon makes a judgment on the spot (operation room) from diagnostic information based on the genetic information, and treats a biomedical tissue at the treatment section 63.

According to the embodiment, a range to be cut can be immediately cut off after the diagnostic information based on the genetic information is output. Thus, by making a diagnosis on the spot, and giving immediate treatment in accordance with the diagnostic information, it is not only possible to reduce a burden on the surgeon or the patient during the operation but also possible to improve accuracy of the diagnostic information.

As described above, by using the diagnostic system of the present invention, highly accurate information, i.e., genetic information, is used in diagnosis, and diagnostic information is transferred through communication. Thus, return of the diagnostic information to the surgeon takes only a little time, and interruption time during the operation can be shortened.

According to the diagnostic system of the present invention, since a highly accurate diagnosis can be made for the patient by using the genetic information, it is possible to discriminate drug solutions likely to cause allergy or the like in accordance with not only the affected portion during the operation but also, e.g., presence of an allergic predisposition of each patient and its kind when the drug solution is administered. By recording such information in a memory card such as an IC card, a danger can be avoided only by checking the IC card at a new hospital or when a new drug solution is administered.

Additionally, if there is no time for inspecting allergy or the like beforehand in the case of an emergency operation, it is possible to avoid a danger of drug solution administration by checking a DNA of a patient even during the operation to specify drug solutions that may cause allergy or the like.

According to the diagnostic apparatus constituted in the foregoing manner, it is possible to quickly obtain diagnostic information by detecting histopathological information during the operation in the operation room, and collating the information with the database disposed in another place through communication.

According to the diagnostic system, histopathological information is detected during the operation in the operation room, and collated with the database disposed in another place through communication. The pathologist makes verification or a diagnosis with respect to diagnostic information obtained by the collation, and the diagnostic information can be quickly notified to the surgeon. Thus, time necessary for a diagnosis is shorted, i.e., time necessary for an operation can be shorted, and accuracy of the diagnosis is improved. As a result, it is possible to reduce a burden on the surgeon or the patient during the operation.

According to the present invention, the genetic information detection section is disposed in a part of the operation instrument to detect histopathological information. The genetic information detection section is brought into contact with a tissue portion regarding which the surgeon wises to obtain information during the operation to collect a part thereof. Diagnostic information of a tissue portion verified by the pathologist can be obtained on the spot, thereby shortening time and improving accuracy of a diagnosis during the operation. According to the diagnostic system of the invention, since the highly accurate genetic information is used for a diagnosis, and conventional transfer of information and diagnostic information is carried out through communication, return of the diagnostic information to the surgeon takes only a little time, and interruption time during the operation can be shortened.

1. A diagnostic apparatus comprising:
genetic information detection means for obtaining a part of a biomedical tissue, and executing hybridization to detect genetic information of the biomedical tissue,
transmission/reception means for converting the genetic information detected by the genetic information detection means into an electric signal to execute communication,
a pathology database in which a plurality of bits of diagnostic information concerned with a plurality of kinds of genetic information are prestored,
diagnostic information search means for collating the genetic information received from the transmission/reception means with the pathology database to search the relevant diagnostic information, and
display means for displaying the diagnostic information searched by the diagnostic information search means.

2. The diagnostic apparatus according to claim 1, wherein:
the genetic information detection means comprises a first operation portion and a second operation portion sealed when abutted on each other;
the first operation portion includes a DNA chip in which a plurality of spots are arrayed to react with the stuck biomedical tissue by the hybridization, and a discharge section which discharges a drug solution applied to the DNA chip to execute the hybridization; and
the second operation portion includes reference cells which confront the spots when gripped, apply the drug solution to the DNA chip, irradiate the cleaned spots with an illuminating light, receive a reflected light, and convert the reflected light into an electric signal to generate genetic information.

3. The diagnostic apparatus according to claim 2, wherein each reference cell comprises:
a liquid discharge section which discharges a sample or a cleaning solution to become the drug solution for the hybridization and cleaning to the spots,
an irradiation opening through which a light is applied to the spots after reaction by the hybridization, and
a light receiving section which receives a reflected light of the light applied to the spots, and generates an electric signal containing genetic information of the reacted spots from the reflected light.

4. A diagnostic system on which a diagnostic apparatus is mounted, comprising:
forceps having a genetic information detection mechanism which includes a DNA chip disposed at a tip of a jaw, executes hybridization of a biomedical tissue stuck to the DNA chip, converts optically detected genetic information into an electric signal, and outputs the electric signal,
a detection processing/information transmission section which is connected to a handle side of the forceps and which supplies/recovers a drug solution for the execution of the hybridization, propagates an irradiating light to the DNA chip, converts the genetic information converted into the electric signal into a radio signal, and transmits the radio signal,
an information reception section which is present apart from the detection processing/information transmission section and which receives the radio signal from the detection processing/information transmission section, and decodes the genetic information,
a pathology database in which diagnostic information concerned with a plurality of kinds of genetic information is prestored,
a diagnostic information search section which collates the received genetic information with the pathology database to search the relevant diagnostic information,
verification display means for displaying to verify that the diagnostic information searched by the diagnostic information search section is correct, and
a display section which displays the diagnostic information verified to be correct by the verification display means in the vicinity of a place in which the forceps are present.

5. The diagnostic system according to claim 4, wherein the forceps comprise:
an upper jaw and a lower jaw,
a handle which opens/closes the upper and lower jaws,
a DNA chip which is mounted on the lower jaw and in which a plurality of spots are arrayed to execute hybridization and cleaning for the stuck biomedical tissue, thereby detecting genetic information of the biomedical tissue,
a discharge path which is formed in the lower jaw and through which a sample or a cleaning solution applied to the DNA chip is discharged to execute the hybridization and the cleaning,
a liquid discharge section which is formed in the upper jaw and which discharges the sample or the cleaning solution to the spots,
an irradiating opening through which a light is applied to the spots after reaction by the hybridization, and
a light receiving section which receives a reflected light of the light applied to the spots, and generates an electric signal containing genetic information from the reacted spot.

6. The diagnostic system according to claim 4,
wherein the genetic information detection mechanism is disposed in an energy treatment tool.

7. The diagnostic system according to claim 4,
wherein the genetic information detection mechanism is disposed in a laparoscopic operation instrument.

8. The diagnostic system according to claim 4,
wherein when a drug is administered based on the diagnostic information, information of presence of an allergic predisposition, and information regarding drugs likely to cause allergy or the like are generated, and a memory card is disposed to record the information.

9. The diagnostic system according to claim 4, wherein:
the forceps having the genetic information detection mechanism, the detection processing/information transmission section, and the display section constitute a first group;
the information reception section, the pathology database, the diagnostic information search section, and the verification display means constitute a second group which is arranged in a place remote from the first group;
a communication line is disposed to execute information communication between the groups; and
the communication line uses one selected from wire communication through a cable, optical communication, ground wave (analog wave) radio communication, ground wave (digital wave) radio communication, and satellite communication, or a combination thereof.
